(19) United States
(12) Patent Application Publication
(10) Pub. No.: US 2026/0158696 A1
(43) Pub. Date: Jun. 11, 2026

(54) System and Method for Securing a Die During Cutting

(71) Applicant: Amplify Holdings LLC, Gilbert, AZ (US)

(72) Inventors: Laura Graff, Mesa, AZ (US); Jessica Harrington, Mesa, AZ (US); McKane Davis, Gilbert, AZ (US)

(21) Appl. No.: 19/180,667

(22) Filed: Apr. 16, 2025

Related U.S. Application Data
(60) Provisional application No. 63/686,591, filed on Aug. 23, 2024.

(51) Int. Cl. B26F 1/02

(52) U.S. Cl. CPC B26F 1/02

(57) ABSTRACT

A die cutting machine mat including a magnetic layer to attract the metal die and prevent its movement during pressing, a first soft layer on the top surface side of the magnetic layer, a second soft layer on the bottom side of the magnetic layer and a rigid plastic layer between the magnetic layer and the second soft layer. The mat may replace the bottom plate of the assembly, and soft layers may be self-healing. At least one of the soft layers may be covered in a sticky coating to better grip the sheet of paper and an adhesive may be placed between at least two of the layers to adhere adjacent layers to each other. The rigid plastic layer and the magnetic layer may be about the same thickness and soft layers may be about one half the thickness of the rigid plastic layer and the magnetic layer.

### CROSS REFERENCE TO RELATED APPLICATIONS

This application claims benefit from currently U.S. Provisional Application No. 63/686,591 titled “System and Method for Securing a Die During Cutting” and having a filing date of Aug. 23, 2024, all of which is incorporated by reference herein.

### FIELD OF THE INVENTION

This disclosure pertains to the field of die cutting machines and related accessories, specifically to a mat designed for use with such machines.

### BACKGROUND OF THE INVENTION

Die cutting machines are commonly used in various industries to cut out shapes from non-metal materials such as paper, fabric, and plastic. These machines typically consist of a die, which is a metal tool with a specially designed shape, and a press, which applies pressure to the die to cut the shape out of the material. The material to be cut is usually arranged in an assembly of one or more sheets, with the die placed on top of the material and a plate placed on top of the die. The assembly is then passed through the press to cut out the shape.

However, one of the challenges in using die cutting machines is ensuring that the die and the material stay in place during the cutting process. Any movement of the die or the material can result in inaccurate cuts, which can lead to waste of material and time. In addition, die plates are prone to warp and curve, or may be scratched or worn from pressing against the metal die.

To address these issues, mats have been developed that can be used with die cutting machines to hold the material in place relative to a sled plate and tape is often used to hold the die relative to the material. Sled plates have been developed incorporating a magnet to attract the metal die, preventing it from moving during the pressing process. These sled plates either do not hold the material in place or hold the die too strongly to the sled plate making them inconvenient to remove by the user.

There remains a need for improvements in the design and construction of mats for use with die cutting machines. In particular, there is a need for mats that can effectively prevent movement of the die and the material during the cutting process, while also being durable, easy to use, and cost-effective.

So as to reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art” and Applicant(s) expressly reserve(s) the right to swear behind any of the incorporated materials.
U.S. Pat. No. 11,584,035B2
U.S. Pat. No. 4,192,494A
US20150196166A1
US20110104425A1
US20230180966A1
US20150197029A1
US20110059309A1
U.S. Pat. No. 7,270,038B1
US20130092040A1
U.S. Pat. No. 7,895,926B2

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57 (c) (1)-(3), applicant(s) will amend the specification to expressly recite the essential material that is incorporated by reference as allowed by the applicable rules.

### SUMMARY OF THE INVENTION

The present invention provides among other things a magnetic sled configured to replace one or more of the die cutting plates used in a typical die cutting machine.

It is an object of the invention to provide a simplified plate assembly for use with a die cutting press with expanded functionality.

It is another object of the invention to provide a more durable plate alternative for a die cutting press that does not warp or bend through repeated use.

It is another object of the invention to provide a die cutting plate assembly that does not require the die to be taped to the material to be cut.

It is another object of the invention to provide a magnetic plate assembly for a die cutting press.

It is another object of the invention to provide an optionally magnetic die cutting press plate that is magnetic on one side and not magnetic on the other side.

It is another object of the invention to provide a magnetic plate for a die cutting press that has a self-healing soft surface.

It is another object of the invention to provide a magnetic plate for a die cutting press that has a self-healing soft surface on each side of the plate.

It is another object of the invention to provide a magnetic plate for a die cutting press that has a magnetic field that is strong enough to hold a thin metal die in place while shaking/moving but that can be removed with a fingernail slipped under the die to pry it loose.

It is another object of the invention to provide a replacement plate for a die cutting press that fits multiple existing die cutting machines.

The above and other objects may be achieved using devices involving a mat for use with a die cutting machine. The mat is designed to allow a user to arrange an assembly of one or more sheets of a non-metal material and a metal die placed between a top plate and a bottom plate. The assembly is then passed through a press to cut out a shape in the one or more sheets of non-metal material. The mat comprises a magnetic layer configured to attract the metal die to prevent movement of the die relative to the magnetic layer during pressing. The magnetic layer has a top surface and a bottom surface.

A first soft layer is located on the top surface side of the magnetic layer and a rigid plastic layer is positioned on the bottom surface of the magnetic layer between the magnetic layer and a second soft layer. The presence of soft layers on both sides of the magnetic layer ensures that the non-metal material is adequately protected, regardless of its position in the assembly.

The mat is configured to replace the bottom plate of the assembly. This allows for a more streamlined and efficient die cutting process, as the user does not need to separately handle and position a bottom plate. The mat effectively serves as a combined bottom plate and protective layer, simplifying the assembly process and reducing the risk of user error. The first and second soft layer may be self-healing. This means that any cuts or marks made on the surface of this layer during the pressing process will automatically repair themselves. The soft layers and the rigid plastic layer may be made of PVC with plasticizers in the soft layers and unplasticized pvc in the rigid plastic layer. The first or second soft layer may be covered in a sticky coating to better grip the sheet of paper to prevent it from moving.

The total combined thickness of the mat is between 2.7 and 3.3 mm. The rigid plastic layer and the magnetic layer may be about the same thickness and the first soft layer and the second soft layer may be about one half the thickness of the rigid plastic layer and the magnetic layer. An adhesive may be placed between at least two of the layers to adhere adjacent layers to each other. The adhesive may be a strong-bond adhesive that is pressed between layers for successful bonding.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF DRAWINGS

A more complete understanding of the present invention may be derived by referring to the detailed description when considered in connection with the following illustrative figures. In the figures, like reference numbers refer to like elements or acts throughout the figures.

FIG. 1 depicts a die cutting press plate assembly according to the prior art;

FIG. 2 depicts a die cutting press utilizing the die cutting press assembly shown in FIG. 1;

FIG. 3 depicts a blown out view of the layers in the mat according to one embodiment of the invention; and

FIG. 4 depicts a layer view in the mat according to one embodiment of the invention.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

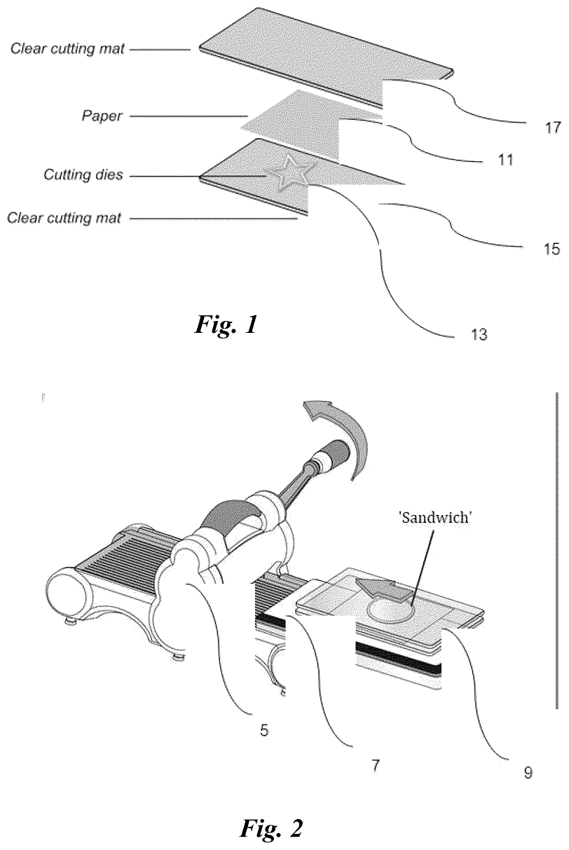

In one application of the invention, a mat 10 is provided for use with a die cutting machine. As shown in FIGS. 1 and 2, the die cutting machine is designed to allow a user to arrange an assembly 9 of one or more sheets of a non-metal material 11 and a metal die 13 placed between a top plate 17 and a bottom plate 15. The plates area typically composed of a hard resin material and are typically between 3 and 5 mm thick. The non-metal material 11 may be paper, fabric, or plastic such as vinyl is typically placed between the die 13 and the bottom plate 15. The assembly 9 is then passed through a press or placed on a sled 7 and passed through a press 5 to cut out a shape in the one or more sheets of non-metal material 11.

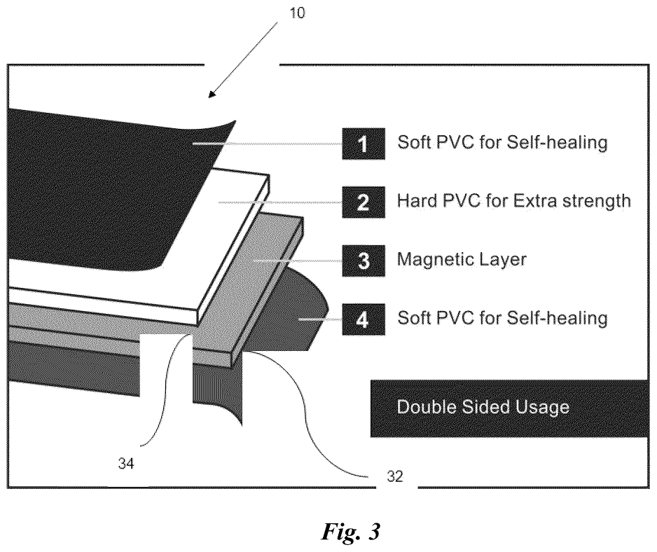

Referring to FIG. 3, the mat 10 of the present invention may replace one or more of the plates used in the assembly. The mat 10 is composed of multiple layers and has a total thickness of about 3 mm. While the improved durability of the mat 10 allows the mat to replace either plate, it is most advantageous to replace the bottom plate of the assembly. With the magnetic properties of the mat 10, it would also be possible for the non-metal material to be placed between the die and the top plate and allow the die to hold the non-metal material in place relative to the top plate.

The mat comprises a magnetic layer 3 with a top surface 32 and a bottom surface 34 configured to attract the metal die 13 to prevent movement of the die 13 relative to the magnetic layer 3 during pressing. The magnetic layer 3 exerts a magnetic field in the direction of one or more of the top surface 32 and the bottom surface 34 of the mat 10. In a particular embodiment, the magnetic field is especially exerted from the top surface 32 of the magnetic layer 3. The magnetic layer 3 interacts with the ferrous metal die 13 to ensure the stability of the die 13 during the pressing process. By attracting the metal die 13, the magnetic layer 3 prevents any unwanted movement of the die 13 that could potentially lead to inaccuracies in the cut-out shape.

A first soft layer 4 can be located on the top-surface side of the magnetic layer 3. This soft layer 4 serves multiple purposes. First, it provides a cushioning effect for the die 13 and the sheet material 11 during the pressing process which can help prevent any damage to the die 13 or the sheet material 11 that could occur due to the high pressures involved in the die cutting process. Secondly, the soft layer 4, 1 also provides a level of friction between the sheet material 11 and the mat 10. This further helps to prevent any unwanted movement of the sheet material 11 relative to the die 13 during the pressing process. The soft layers 4, 1 may be made from the same or different soft materials. The soft material is preferably made from a self-healing material, which means that any cuts or marks made on these layers during the die cutting process will automatically heal or close up after the process is completed which can significantly extends the lifespan of the mat and reduces the need for frequent replacements. Self-healing materials include such as, for example, soft PVC (PVC containing additional plasticizers such as phthalates), elastomers such as polyurethane, ionic conductive polymers, dynamic covalent polymers, thermoplastic polyurethane, polydimethysiloxane, hydrogel, polymer gels, or the like. In a particular embodiment, the soft layers are primarily composed of plasticized PVC.

A second soft layer 1 can be located on the bottom-surface side of the magnetic layer 3. This second soft layer 1 provides second softer surface for cutting when the mat 10 is flipped onto the other side. The soft layers 1,4 on both sides of the mat 10 provide additional cushioning and frictional support to the mat 10 and help to prevent any unwanted movement of the mat 10 during the pressing process. It also provides a level of protection for the other plate of the die cutting machine that is not replaced by the mat 10.

The mat 10 can be placed so that the first soft layer 4 or the second soft layer 1 supports the die 13. The magnetic layer 3 and rigid plastic layer 2 can be configured to allow the magnetic layer 3 to exert a magnetic field on the die 13 when the first soft layer 4 is supporting the sheet material 11 and to not exert a magnetic field on the die 13 when the second soft layer 1 supports the sheet material 11. In some embodiments, the user may choose to use the mat as a magnetic mat or not by determining which side of the mat 10 supports the sheet material 11. To switch between magnetic functionality and non-magnetic functionality the user need merely flip the mat over.

A rigid plastic layer 2 can be positioned between the magnetic layer 3 and the first soft layer 1. This rigid layer 2 provides structural support to the mat 10. It helps to maintain the shape and integrity of the mat 10 during the pressing process. Without this rigid layer 2, the mat could potentially deform under the high pressures of the die cutting process. This could lead to inaccuracies in the cut-out shape or even damage to the die 13 or the sheet material 11. The rigid plastic layer 2 may be composed of unplasticized PVC (uPVC), or a similar material such as polypropylene, polycarbonate, acrylonitrile butadiene styrene, high density polyethylene, Nylon polyamide, polyethylene terephthalate, acrylic, fiber reinforced plastic, polyoxymethylene, or the like.

In some embodiments, the mat 10 is configured to replace the bottom plate 15 of the assembly 9. In some embodiments, the first soft layer is self-healing which can mean that any cuts or marks made on the first soft layer during the die cutting process will automatically heal or close up after the process is completed. This significantly extends the lifespan of the mat 10 and reduces the need for frequent replacements. In some embodiments, the first soft layer 4 and the rigid plastic layer 2 are made of PVC. PVC is a durable and cost-effective material that is well-suited to the demands of the die cutting process. It provides a good balance of rigidity and flexibility, making it an ideal choice for both the soft and rigid layers of the mat.

In some embodiments, the first soft layer 4 is covered in a sticky coating, which can create a better grip to the sheet of paper 11 and prevent it from moving during the pressing process. This further enhances the accuracy of the cut-out shape and reduces the risk of any errors or inaccuracies. In certain embodiments, the sticky coating can have variable tackiness that automatically adjusts to environmental humidity conditions, ensuring consistent performance across diverse operating environments while preventing substrate movement during the critical pressing process. In other embodiments, the sticky coating can have photochromic indicators that visually display optimal contact areas through color-changing properties, enabling operators to confirm proper sheet placement before initiating the cutting sequence. The perimeter of the soft layer features a slightly elevated boundary ridge with enhanced adhesive properties, creating a secure containment zone that further restricts lateral displacement even under high-pressure applications. These integrated retention features significantly enhance the dimensional accuracy of the resultant cut-out shape, minimize material waste due to misalignment, and substantially reduce the probability of production errors or geometric inaccuracies.

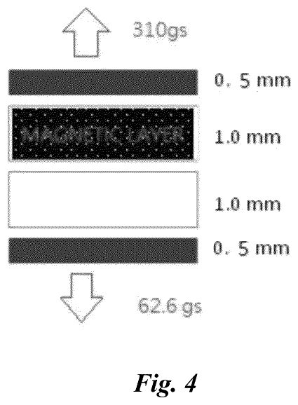

In some embodiments, and referring to FIG. 4, the total combined thickness of the mat 10 is between 2.7 and 3.3 mm. This thickness range provides an optimal balance of rigidity and flexibility for the mat and allows the mat to replace one of the plates 15, 17. The first and second soft layers 1, 4 may each be about 0.5 mm thick, and the hard layer 2 and the magnetic layer 3 about 1 mm thick each. The thickness and materials of the mat 10 can ensure that the mat is sturdy enough to withstand the pressures of the die cutting process, while still being flexible enough to allow for accurate and precise cut-out shapes. The strength of the magnetic field is calibrated by the thickness and material used for the magnetic layer to allow the magnetic field to hold the metal die in place while shaking or moving but allowing the metal die to be lifted by a fingernail slipped under the die to pry it loose.

The layers of the mat can be adhered to each other. This ensures that the layers remain securely in place during the pressing process, which can prevent any unwanted movement or shifting of the layers that could potentially lead to inaccuracies in the cut-out shape. The layers may be adhered with a strong-bond adhesive such as epoxy, cyanoacrylate, polyurethane, silicone, hot melt adhesives, polyvinyl acetate and the like and compressed for a firm hold. In certain embodiments, each interface between adjacent layers can be treated with a specialized dual-phase adhesive matrix that creates both mechanical and chemical bonds. The primary bonding agent can comprise of a modified polyurethane compound with enhanced cross-linking properties, supplemented with nano-scale silicate reinforcement particles that create three-dimensional bonding bridges between layers. The adhesive system can be applied using a controlled distribution pattern that concentrates additional bonding material at high-stress regions while maintaining uniform thickness of 0.08 mm+0.01 mm across the entire bonding surface. Following application, the assembled layers undergo a compression curing process at 2.0-5.0 MPa and 40-60° C. for 45-75 minutes, creating a permanent molecular integration at each interface. The resulting bond can help prevent any lateral displacement between layers even under extreme operational conditions. Additionally, the perimeter of the mat features a specially formulated edge sealant that prevents delamination initiation and protects against moisture infiltration, extending the functional lifespan of the mat.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

We claim:

1. A mat for use with a die cutting machine that allows a user to arrange an assembly of one or more sheets of a non-metal material and a metal die placed between a top plate and a bottom plate and passes the assembly through a press to cut out a shape in the one or more sheets non-metal material, the mat comprising:
a magnetic layer configured to attract the metal die to prevent movement of the die relative to the magnetic layer during pressing, the magnetic layer having a top surface and a bottom surface,
a first soft layer on the top surface side of the magnetic layer;
a second soft layer on the bottom surface side of the magnetic layer; and
a rigid plastic layer between the magnetic layer and the first soft layer.

2. The mat of claim 1, wherein the mat is configured to replace the bottom plate of the assembly.

3. The mat of claim 1, wherein the first soft layer is self-healing.

4. The mat of claim 1 wherein the first soft layer and the rigid plastic layer are made of PVC.

5. The mat of claim 1 wherein the first soft layer is covered in a sticky coating to better grip the sheet of paper to prevent it from moving.

6. The mat of claim 1 wherein the total combined thickness of the mat is between 2.7 and 3.3 mm.

7. The mat of claim 1 wherein the rigid plastic layer is unplasticized PVC.

8. The mat of claim 4, wherein the rigid plastic layer is unplasticized PVC.

9. The mat of claim 1, wherein the first soft layer and the second soft layer are composed of a self-healing material.

10. The mat of claim 1, wherein an adhesive is placed between at least two of the layers to adhere adjacent layers to each other.

11. The mat of claim 10 wherein the adhesive is a strong-bond adhesive.

12. The mat of claim 1 wherein the rigid plastic layer and the magnetic layer are about the same thickness and the first soft layer and the second soft layer are about one half the thickness of the rigid plastic layer and the magnetic layer.

13. The mat of claim 1 further comprising measurement marks on the first and second soft layers.
